(19) United States
(12) Patent Application Publication
(10) Pub. No.: US 2022/0380264 A1
(43) Pub. Date: Dec. 1, 2022

(54) METHOD OF FORMING CERAMIC MATRIX COMPOSITE AND CERAMIC MATRIX COMPOSITE

(71) Applicants: MITSUBISHI HEAVY INDUSTRIES AERO ENGINES, LTD., Aichi (JP); THE UNIVERSITY OF TOKYO, Tokyo (JP)

(72) Inventors: Hiromichi AKIYAMA, Tokyo (JP); Kiichi NISHIGUCHI, Tokyo (JP); Takahiro SEKIGAWA, Tokyo (JP); Akira FUKUSHIMA, Aichi (JP); Takeshi YOSHIKAWA, Tokyo (JP); Hisao ESAKA, Tokyo (JP)

(21) Appl. No.: 17/824,648

(22) Filed: May 25, 2022

(30) Foreign Application Priority Data
May 28, 2021 (JP) 2021-090193

(51) Int. Cl. C04B 35/628; C04B 35/634; C04B 35/83; C04B 41/51; C04B 41/88

(52) U.S. Cl. CPC C04B 35/62863; C04B 35/63452; C04B 35/83; C04B 41/5183; C04B 41/88; C04B 2235/3826; C04B 2235/428; C04B 2235/5252; C04B 2235/5248; C04B 2235/616

(57) ABSTRACT

A method of forming a ceramic matrix composite with being impregnated with molten metal includes: stacking a plurality of fiber layers that are layers of reinforced fibers impregnated with base resin to form a laminate in which a matrix layer containing fibers extending in a direction of impregnation with the molten metal is disposed between the fiber layers; forming an impregnation path in the matrix layer entirely in an in-plane direction perpendicular to a direction of the stacking in the laminate by carbonizing the formed laminate; and impregnating, with the molten metal, the laminate in which the impregnation path has been formed.

### CROSS-REFERENCE TO RELATED APPLICATIONS

The present application claims priority to and incorporates by reference the entire contents of Japanese Patent Application No. 2021-090193 filed in Japan on May 28, 2021.

### FIELD

The present disclosure relates to a method of forming a ceramic matrix composite and a ceramic matrix composite.

### BACKGROUND

Conventionally, a method of manufacturing a ceramic matrix composite using the melt-infiltrated (MI) method is known as a method of forming a ceramic matrix composite (see, for example, Patent Literature 1). In this manufacturing method, a fiber reinforcement material is impregnated with a matrix slurry containing a resin binder and a pore-forming agent, whereby a preform is obtained. The preform is then heated for carbonization of the resin binder while pore formation is promoted by the action of the pore-forming agent. A porous preform is thus formed. In this manufacturing method, the pores of the porous preform are then filled with molten silicon, whereby silicon carbide is formed.

### CITATION LIST

### Patent Literature

Patent Literature 1: Japanese Laid-open Patent Publication No. 2013-241327

### SUMMARY

### Technical Problem

A matrix slurry, which is base resin, may contain a large amount of filler containing carbon, silicon carbide, or the like. In this case, when a porous preform is formed using a pore-forming agent as described in Patent Literature 1, an impregnation path to be impregnated with the molten silicon is fragmented by the filler, and it may be therefore difficult to form an appropriate impregnation path. Without an appropriate impregnation path formed, impregnation with molten silicon may stop halfway, and some areas may be left not impregnated. As a result, defects such as voids or cracks are likely to occur. When pores formed by the pore-forming agent are large, unreacted silicon that has not reacted with carbon may be left even after impregnation with molten silicon. This may reduce the strength of the formed ceramic matrix composite.

Given these inconveniences, the subject of the present disclosure is to provide a method of forming a ceramic matrix composite and a ceramic matrix composite that enable suitable formation of a ceramic matrix composite while defects in formation are prevented from occurring.

### Solution to Problem

A method of forming a ceramic matrix composite with being impregnated with molten metal or alloy according to one aspect of the present disclosure includes: stacking a plurality of fiber layers that are layers of reinforced fibers impregnated with base resin to form a laminate in which a matrix layer containing fibers extending in a direction of impregnation with the molten metal or alloy is disposed between the fiber layers; forming an impregnation path in the matrix layer entirely in an in-plane direction perpendicular to a direction of the stacking in the laminate by carbonizing the formed laminate; and impregnating, with the molten metal or alloy, the laminate in which the impregnation path has been formed.

A ceramic matrix composite according to another aspect of the present disclosure includes: a plurality of fiber layers that are layers containing ceramic-matrix reinforced fibers; and a matrix layer provided in the fiber layers stacked in a stacking direction, the matrix layer having been formed in a manner that an impregnation path formed entirely in an in-plane direction perpendicular to the stacking direction of the fiber layers is impregnated with molten metal or alloy to react.

### Advantageous Effects of Invention

According to the present disclosure, a ceramic matrix composite can be suitably formed while defects in formation are prevented from occurring.

### BRIEF DESCRIPTION OF DRAWINGS

FIG. 1 is a sectional view illustrating a ceramic matrix composite according to the present embodiment.

FIG. 2 illustrates an example of a method of forming a ceramic matrix composite according to the present embodiment.

FIG. 3 illustrates another example of the method of forming a ceramic matrix composite according to the present embodiment.

### DESCRIPTION OF EMBODIMENTS

The following describes an embodiment according to the present disclosure in detail based on the drawings. This invention is not limited by this embodiment. The components in the following embodiments include those that are substitutable and easy for those skilled in the art, or those that are substantially the same. Furthermore, the components described below can be combined as appropriate, and, when there are a plurality of embodiments, any two or more of the embodiments can be combined.

### EMBODIMENT

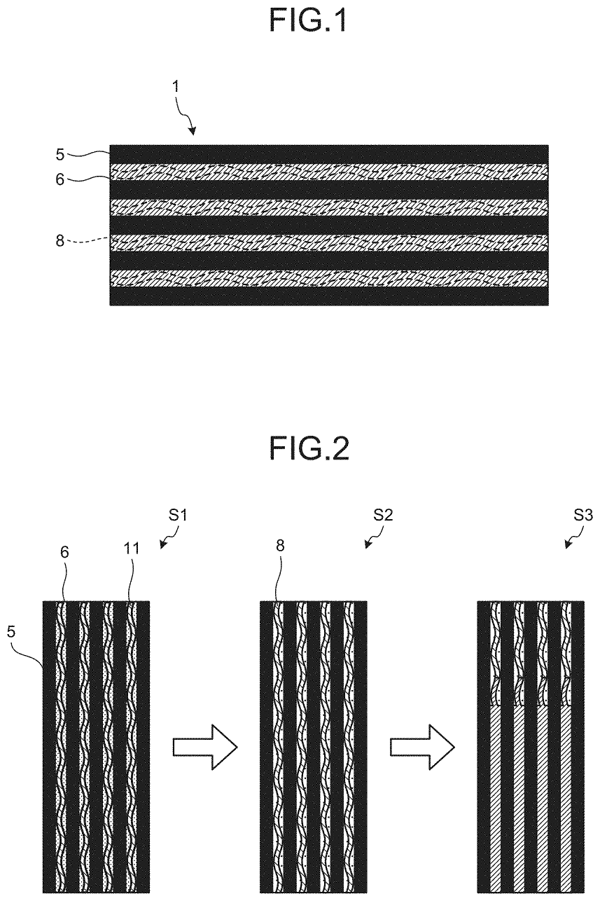

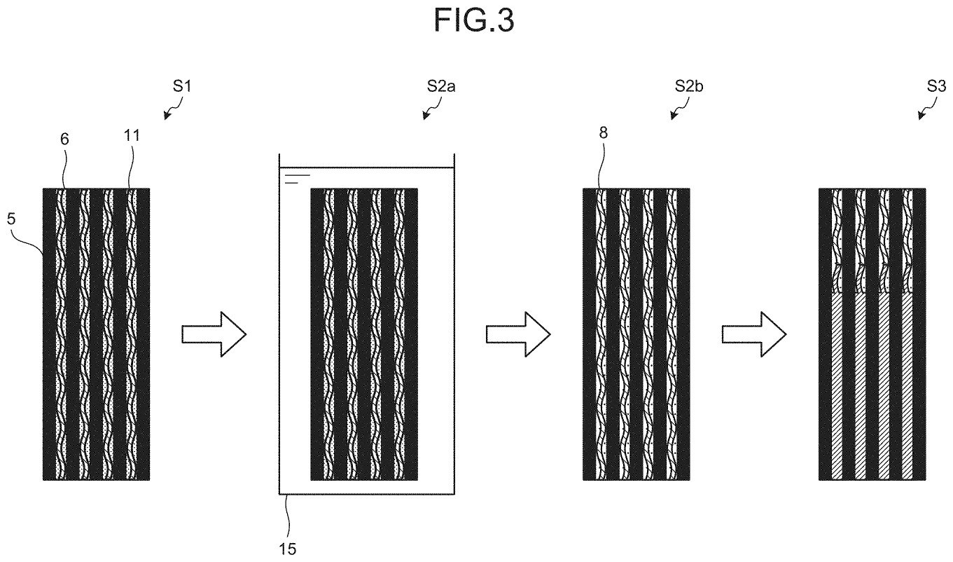

FIG. 1 is a sectional view illustrating a ceramic matrix composite according to the present embodiment. FIG. 2 illustrates an example of a method of forming a ceramic matrix composite according to the present embodiment. FIG. 3 illustrates an example of a method of forming a ceramic matrix composite according to the present embodiment.

The method of forming a ceramic matrix composite according to the present embodiment is a forming method using the melt impregnation process (MI process). The ceramic matrix composite is, for example, a silicon carbide (SiC) composite, specifically, a SiC fiber-reinforced SiC matrix composite (SiC/SiC composite). With reference to FIG. 1, a ceramic matrix composite 1, which is a SiC/SiC composite, is described first before the method of forming a ceramic matrix composite is described. A ceramic matrix composite is not limited to a SiC/SiC composite and may be any ceramic matrix composite that can be formed using the forming method according to the present embodiment.

Ceramic Matrix Composite

As illustrated in FIG. 1, the ceramic matrix composite 1 has fiber layers 5 each containing ceramic-matrix reinforced fibers and a matrix layer 6 provided between each two layers of the fiber layers 5 stacked in a stacking direction.

The fiber layers 5 are layers mainly made of fibers, for which SiC fibers are used as the ceramic-matrix reinforced fibers. The fiber layer 5 is formed in a manner that a green body is obtained by laminating and curing prepregs each obtained by impregnating base resin with carbon fibers; and the green body is carbonized and is impregnated with and caused to react with molten silicon, which is provided as molten metal or alloy. The prepregs are each formed using, for example, a unidirectional material in which the SiC fibers extend in one direction, and are stacked so that directions in which the SiC fibers in the different prepregs can be different. The base resin is, for example, thermosetting resin such as epoxy resin. The base resin contains filler, and at least one of powdered carbon and powdered silicon carbide is used as the filler. Thus, the base resin is a thermosetting resin that contains filler.

The matrix layer 6 is a layer containing silicon carbide. The matrix layer 6 is formed in such a manner that: an impregnation path 8 is formed in a manner that fibers 11 (see FIG. 2) described below are carbonized; and this impregnation path 8 is impregnated with and reacted with molten silicon. The impregnation path 8 in the matrix layer 6 is formed so that a space to be filled with molten silicon can be entirely continuous in an in-plane direction perpendicular to the stacking direction of the fiber layers 5. As a result of impregnating the impregnation path 8 with molten silicon, the matrix layer 6 becomes a layer that has silicon carbide formed along the impregnation path 8.

Method of Forming Ceramic Matrix Composite

Next, the method of forming the ceramic matrix composite 1 is described with reference to FIG. 2. In the method of forming the ceramic matrix composite 1, a laminate that serves as a green body, in which the fiber layers 5 and the matrix layers 6 are stacked on one another, is formed (step S1). At step S1, a plurality of prepregs in each of which the fiber layer 5 and the matrix layer 6 without the fibers 11 are integrated are stacked, and the fibers 11 are placed between each two layers of the prepregs. In other words, at step S1, the prepregs and the fibers 11 are consecutively stacked alternately. At step S1, optionally, each of the prepregs and the corresponding fibers 11 may be integrated into a sheet, and a plurality of such sheets may be consecutively laminated. Thereafter, at step S1, the laminated prepregs are heated, whereby the matrix layers 6 are molten and integrated with the fibers 11. The laminated prepregs are further heated, whereby the fiber layers 5 and matrix layers 6 are thermally cured to form the laminate. As a result, the matrix layers 6 each containing the fibers 11 extending entirely in an in-plane direction of the laminate is formed. The fibers 11 used in the matrix layers 6 are inorganic, such as carbon fibers having binder resin attached thereto or SiC fibers having binder resin attached thereto, or organic fibers. The organic fibers may have binder resin attached thereto. The fibers 11 used in the matrix layers 6 take the form of non-woven cloth, woven cloth, or a unidirectional material. In the fibers 11 used in the matrix layers 6, the fibers therefore extend in directions along in-plane directions of the laminate.

When the matrix layers 6 are carbonized, the impregnation paths 8 are formed in directions (in-plane directions) in which the fibers 11 extend, through carbonization of the binder resin in a case using carbon fibers or SiC fibers as the fibers 11 or through carbonization of the fibers themselves in a case using organic fibers as the fibers 11. In this stage, the binder resin and the organic fibers are resins having lower decomposition temperatures than that of the base resin of the fiber layers 5. For example, when epoxy resin is used as the base resin, polyvinyl chloride (PVC), poly methyl methacrylate (PMMA, which is also referred to as acrylic), or the like is used as the binder resin and the organic fibers.

The fibers 11 in the matrix layer 6 have a fiber diameter of 0.5 to 20 μm, more preferably 1 to 7 μm, and still more preferably 1 to 5 μm. The fibers 11 in the matrix layer 6 have a weight per unit area of 20 g/m² or less and preferably 8 g/m² or less.

In the method of forming the ceramic matrix composite 1, the formed laminate is carbonized, whereby the impregnation paths 8 are formed in the matrix layers 6 entirely in in-plane directions of the laminate (step S2). At step S2, the laminate is carbonized, whereby the laminate in which the impregnation paths 8 have been formed is formed as a precursor of the ceramic matrix composite 1. At step S2, in a case using carbon fibers or SiC fibers as the fibers 11 in the matrix layers 6, the binder resin attached to the fibers 11 are carbonized. As a result, the impregnation paths 8 to be impregnated with molten silicon are formed, and carbon is formed inside the impregnation paths 8. At step S2, in a case using organic fibers as the fibers 11 in the matrix layers 6, the fibers 11 themselves are carbonized. As a result, the impregnation paths 8 to be impregnated with molten silicon are formed, and carbon is formed inside the impregnation paths 8. The impregnation paths 8 formed at step S2 also function as degassing paths for decomposition gas generated through carbonization of the base resin, thus allowing the laminate to be prevented from cracking.

Thereafter, in the method of forming the ceramic matrix composite 1, the laminate in which the impregnation paths 8 have been formed that serves as a precursor is impregnated with molten silicon (step S3). At step S3, the laminate is impregnated with molten silicon along the impregnation paths 8 formed at step S2. Molten silicon with which the laminate is impregnated becomes silicon carbide by reacting with carbon in the impregnation paths 8, carbon in the carbonized base resin, and carbon in the filler contained in the base resin. When the fibers 11 in the matrix layers 6 are carbon fibers, molten silicon reacts with the carbon fibers and produces SiC fibers. The method of forming the ceramic matrix composite 1 ends by executing step S3.

For example, it has been confirmed that the impregnation paths 8 are impregnated with molten silicon in a case where: a filler-containing base resin, which is difficult to impregnate, is applied as the base resin of the fiber layers 5; a non-woven carbon fiber cloth having a fiber diameter of 7 μm and a weight per unit area of 8 g/m² is applied as the fibers 11; and PVA binder resin that accounts for 16% by weight of this non-woven cloth is attached to this non-woven cloth.

Next, with reference to FIG. 3, another example of a method of forming ceramic matrix composite 1 is described. In the molding method of FIG. 3, at step S2 of forming the impregnation path 8 in the matrix layer 6, the fibers 11 in the matrix layer 6 in the laminate or the binder resin attached to the fibers 11 is dissolved before the laminate is carbonized. In other words, in the molding method of FIG. 3, when the fibers 11 used in the matrix layer 6 are to be dissolved, fibers that are dissolved by a solvent are used. In the molding method of FIG. 3, when the fibers 11 used in the matrix layer 6 are not dissolved, it is preferable that the binder resin be attached to the fibers 11. Steps S1 and S3 illustrated in FIG. 3 are the same as steps S1 and S3 illustrated in FIG. 2, and description thereof is therefore omitted.

At step S2, the formed laminate is immersed in a liquid bath 15 filled with a solvent, whereby the fibers 11 or the binder resin in the matrix layer 6 in the laminate is dissolved (step S2a). For example, acid is used as the solvent. At step S2a, the fibers 11 or the binder resin in the matrix layer 6 is dissolved, whereby the impregnation path 8 is formed in the matrix layer 6 entirely in an in-plane direction of the laminate. At step S2a, after the fibers 11 are dissolved, the laminate is pulled out of the liquid bath 15 and the laminate is washed as appropriate. Subsequently, at step S2, the laminate from which the fibers 11 or the binder resin has been removed is carbonized, whereby the base resin remaining in the matrix layer 6 is carbonized (step S2b). At step S2b, carbonizing the base resin and the remaining fibers 11 results in formation of carbon in the impregnation path 8. This is possible because the impregnation paths 8 has already been formed at step S2a.

Thus, also in the molding method of FIG. 3, the impregnation path 8 is formed, and carbon is formed inside the impregnation path 8, at step S2. When the hollow region (cavity) in the impregnation path 8 is large, it is difficult to have carbon formed in the impregnation path 8 in the carbonization process at step S2. At step S3 that follows, however, the impregnation path 8 becomes silicon carbide as a result of an impregnation process, where silicon carbide is formed through chemical combination of carbon supplied from the surroundings of the impregnation path 8 and molten silicon that has penetrated the impregnation path 8.

As described above, the method of forming the ceramic matrix composite 1 and the ceramic matrix composite 1 according to the embodiment are understood, for example, as follows.

The method of forming the ceramic matrix composite 1 according to a first aspect is a method for forming the ceramic matrix composite 1 through impregnation with molten metal or alloy (for example, molten silicon). This method of forming the ceramic matrix composite 1 executes: step S1 of stacking a plurality of the fiber layers 5, which are layers of reinforced fibers impregnated with base resin, and forming a laminate by disposing, in the fiber layers 5, the matrix layers 6 containing the fibers 11 extending in a direction of impregnation with the molten metal or alloy; step S2 of forming the impregnation path 8 entirely in the matrix layer 6 in an in-plane direction perpendicular to a direction of the stacking in the laminate by carbonizing the formed laminate; and step S3 of impregnating, with the molten metal or alloy, the laminate in which the impregnation paths 8 has been formed.

According to this configuration, the fibers 11 extending in the direction of impregnation with the molten metal or alloy are contained in the matrix layer 6. Thus, the impregnation path 8 can be formed entirely in the in-plane direction of the matrix layer 6 in the laminate. As a result, the appropriate impregnation path 8 can be formed without having the impregnation path 8 fragmented. Therefore, the laminate can be appropriately impregnated with molten silicon along the impregnation path 8, and a ceramic matrix composite can be suitably formed while defects in formation, such as voids, cracks, and unreacted Si formation, are prevented from occurring.

In a second aspect, the fibers 11 in the matrix layer 6 take the form of non-woven cloth, woven cloth, or a unidirectional material.

According to this configuration, the impregnation path 8 can be appropriately formed entirely in an in-plane direction in the matrix layers 6.

In a third aspect, the fibers 11 in the matrix layers 6 have a fiber diameter of 0.5 to 20 μm.

According to this configuration, the impregnation path 8 that is easily impregnated with the molten metal or alloy can be formed, allowing carbon and the molten metal or alloy to efficiently react with each other.

In a fourth aspect, the fibers 11 in the matrix layer 6 have a fiber diameter of 1 to 7 μm.

In a fifth aspect, the fibers 11 in the matrix layer 6 have a fiber diameter of 1 to 5 μm.

According to each of these configurations, the impregnation paths 8 that is more easily impregnated with the molten metal or alloy can be formed, allowing carbon and the molten metal or alloy to more efficiently react with each other.

In a sixth aspect, the fibers 11 in the matrix layer 6 have a weight per unit area is 20 g/m² or less.

According to this configuration, the fibers 11 in the matrix layer 6 can have a weight per unit area that allows the fibers 11 to be uniformly disposed in the matrix layer 6. The impregnation path 8 can be thus formed uniformly in the matrix layer 6.

In a seventh aspect, the fibers in the matrix layers have a weight per unit area of 8 g/m² or less.

According to this configuration, the fibers 11 in the matrix layer 6 can have a weight per unit area that allows the fibers 11 to be more uniformly disposed in the matrix layer 6. The impregnation path 8 can be thus formed more uniformly in the matrix layer 6.

In an eighth aspect, the fibers 11 in the matrix layer 6 are carbon fibers to which binder resin has been attached, inorganic fibers to which binder resin has been attached, or organic fibers.

According to this configuration, the number of options for the fibers 11 is increased, and carbon can be appropriately formed inside the impregnation path 8.

In a ninth aspect, the binder resin and the organic fibers are resins having lower decomposition temperatures than that of the base resin.

According to this configuration, during the carbonization of the laminate, any volatile components in the binder resin and the organic fibers can be volatilized before the base resin is. As a result, the impregnation path 8 can be used as a flow path for volatilization of any volatile component in the base resin, whereby cracks can be prevented from occurring.

In a tenth aspect, at the step of forming the impregnation path 8 in the matrix layer 6, the fibers 11 in the matrix layer 6 in the laminate are dissolved before the laminate is carbonized.

According to this configuration, the impregnation path 8 can be formed by having the fibers 11 dissolved.

The ceramic matrix composite 1 according to an eleventh aspect includes: the fiber layers 5 that are layers containing ceramic-matrix reinforced fibers; and the matrix layer 6 provided in the fiber layers 5 stacked in a stacking direction. The matrix layer 6 is formed in a manner that the impregnation path 8 formed entirely in an in-plane direction perpendicular to the stacking direction of the fiber layers 5 is impregnated with molten metal or alloy to react.

According to this configuration, silicon carbide can be formed along the impregnation path 8, allowing for high strength.

### REFERENCE SIGNS LIST

1 Ceramic matrix composite
5 Fiber layer
6 Matrix layer
8 Impregnation path
11 Fiber
15 Liquid bath

1. A method of forming a ceramic matrix composite with being impregnated with molten metal, the method comprising:
stacking a plurality of fiber layers that are layers of reinforced fibers impregnated with base resin to form a laminate in which a matrix layer containing fibers extending in a direction of impregnation with the molten metal is disposed between the fiber layers;
forming an impregnation path in the matrix layer entirely in an in-plane direction perpendicular to a direction of the stacking in the laminate by carbonizing the formed laminate; and
impregnating, with the molten metal, the laminate in which the impregnation path has been formed.

2. The method of forming a ceramic matrix composite according to claim 1, wherein the fibers in the matrix layer take a form of non-woven cloth, woven cloth, or a unidirectional material.

3. The method of forming a ceramic matrix composite according to claim 1, wherein the fibers in the matrix layer have a fiber diameter of 0.5 to 20 μm.

4. The method of forming a ceramic matrix composite according to claim 3, wherein the fibers in the matrix layer have a fiber diameter of 1 to 7 μm.

5. The method of forming a ceramic matrix composite according to claim 4, wherein the fibers in the matrix layer have a fiber diameter of 1 to 5 μm.

6. The method of forming a ceramic matrix composite according to claim 1, wherein the fibers in the matrix layer have a weight per unit area of 20 g/m² or less.

7. The method of forming a ceramic matrix composite according to claim 6, wherein the fibers in the matrix layer have a weight per unit area of 8 g/m² or less.

8. The method of forming a ceramic matrix composite according to claim 1, wherein the fibers in the matrix layers are carbon fibers to which binder resin is attached, inorganic fibers to which binder resin is attached, or organic fibers.

9. The method of forming a ceramic matrix composite according to claim 8, wherein the binder resin and the organic fibers are resins having lower decomposition temperatures that of than the base resin.

10. The method of forming a ceramic matrix composite according to claim 1, wherein forming the impregnation path in the matrix layer includes dissolving the fibers in the matrix layer in the laminate before the laminate is carbonized.

11. A ceramic matrix composite comprising:
a plurality of fiber layers that are layers containing ceramic-matrix reinforced fibers; and
a matrix layer provided in the fiber layers stacked in a stacking direction, the matrix layer having been formed in a manner that an impregnation path formed entirely in an in-plane direction perpendicular to the stacking direction of the fiber layers is impregnated with molten metal to react.
